(19) United States
(12) Patent Application Publication
(10) Pub. No.: US 2022/0200423 A1
(43) Pub. Date: Jun. 23, 2022

(54) STATOR HOUSING FOR AN AXIAL FLUX MACHINE

(71) Applicant: YASA Limited, Kidlington (GB)

(72) Inventors: Tim Woolmer, Waterperry (GB); Mario Gomez, Kidlington (GB); Ian Welsh, Kidlington (GB); Simon Jayes, Kidlington (GB)

(21) Appl. No.: 17/554,599

(22) Filed: Dec. 17, 2021

(30) Foreign Application Priority Data
Dec. 18, 2020 (GB) 2020116.6

(51) Int. Cl. H02K 15/12; H02K 1/18; H02K 21/24; B29C 45/14; B29C 45/00; B29C 65/16; B29C 65/00

(52) U.S. Cl. CPC H02K 15/12; H02K 1/182; H02K 21/24; B29C 45/1459; B29K 2309/08; B29C 45/0053; B29C 65/16; B29C 66/7392; B29C 45/0001

(57) ABSTRACT

Described herein is a method of manufacturing a housing for the stator of an axial flux permanent magnet machine. The housing has a cylindrical wall including a metal outer ring lined with a polymer inner ring. The method includes positioning the metal outer ring in an injection moulding machine, and with the injection moulding machine injection moulding a polymer resin onto an inner surface of the metal outer ring to fabricate the polymer inner ring. The polymer inner ring includes a gripping surface arranged to grip a portion of the outer ring, for example moulded around a formation on an inner surface of the metal outer ring. The housing is manufactured using the metal outer ring and the polymer inner ring.

### FIELD

This specification describes methods of manufacturing a housing for the stator of an axial flux permanent magnet machine using injection moulding, housings manufactured by the methods, and machines incorporating the housings.

### BACKGROUND

An axial flux permanent magnet machine typically has disc- or ring-shaped rotor and stator structures arranged about an axis. The stator comprises a set of coils each of which may be parallel to the axis. The rotor bears a set of permanent magnets and is mounted on a bearing so that it can rotate about the axis driven by fields from the stator coils.

FIG. 1a shows the general configuration of an axial flux machine with a pair of rotors R1, R2 to either side of a stator S, although a simple structure could omit one of the rotors. There is an air gap G between a rotor and a stator, and in an axial flux machine a direction of magnetic flux through the air gap is substantially axial.

There are various configurations of axial flux permanent magnet machine depending upon the arrangement of north and south poles on the rotors. FIG. 1b illustrates the basic configurations of a Torus NS machine, a Torus NN machine (which has a thicker yoke because the NN pole arrangement requires flux to flow through the thickness of the yoke), and a YASA (Yokeless and Segmented Armature) topology. The illustration of the YASA topology shows cross-sections through two coils, the cross-hatched area showing the windings around each coil.

In the YASA topology dispensing with the stator yoke provides a substantial saving in weight and iron losses, but drawbacks of removing the stator yoke are a) loss of the structural strength to the stator (which the iron provided) even though there is potentially increased need for strength because of the YASA topology which, being a compact design, can result in very large stresses and (b) loss of a route for heat to escape from stator coils. To address both issues, i.e. the high torque density of the YASA design and generation of significant quantities of heat, a housing for the stator should provide great strength and rigidity to address torque demands, and should also define a chamber which can be supplied with coolant for the machine.

The desired features of a housing for the stator assembly of an axial flux permanent magnet machine, especially one having a YASA topology, impose conflicting requirements. Conventional manufacturing techniques are not able to combine the desired features adequately. General background information relating to the production of reinforced articles can be found in, for example, WO2013/077277, WO2016/129391, WO2012/022974 and WO2015/036780.

In WO2012/022974 and WO2015/036780, axial flux permanent magnet machine assemblies having a clamshell-type stator housing are proposed. The clamshell-type stator housing comprises a pair of end wall plates, one at either end of the stator, linked via a generally cylindrical wall section forming a ring around the stator. The cylindrical wall section may be injection moulded using a polymer resin. The end wall plates and a portion of the length of the cylindrical section form a clamshell.

Once assembled, the polymer clamshell-type stator housing may itself be bolted to a further outer housing, for example in an aluminium housing. In particular, the polymer of the ring around the stator may have holes for receiving bolts for bolting to corresponding holes in the further aluminium outer housing. The polymer stator housing is required for its ability to provide a hermetically sealed cavity (apart from ports as described later) suitable for pumping coolant through. The polymer stator housing must also be thick enough to have enough structural strength to withstand the torque of the machine and to be provided with large enough bolt holes to secure the polymer stator housing to the aluminium outer housing. The aluminium housing in which the polymer housing is bolted in turn provides additional structural strength to withstand the stresses and strains of operation of the machine. Whilst this double housing arrangement provides the desired sealing and strength properties, it increases the space the machine takes up, increases the cost of the machine, and increases the assembly time of the machine.

### SUMMARY

According to one aspect there is provided a method of manufacturing a housing for the stator of an axial flux, e.g. permanent magnet, machine. The machine has a stator comprising a set of coils wound on respective stator bars and disposed circumferentially at intervals about an axis of the machine, and a rotor bearing a set of permanent magnets and mounted for rotation about the axis. The rotor and stator are spaced apart along the axis to define a gap there between in which magnetic flux in the machine is generally in an axial direction. The housing may have a cylindrical wall comprising a metal outer ring lined with a polymer inner ring. The method may comprise positioning the metal outer ring in an injection moulding machine and, with the injection moulding machine, injection moulding a polymer resin onto an inner surface of the metal outer ring to fabricate the polymer inner ring. The polymer inner ring may comprise a gripping surface arranged to grip a portion of the outer ring.

Lining the inside surface of the outer metal ring with an injection moulded layer of polymer having a gripping surface arranged to grip the metal outer ring provides the advantages of hermetic sealing and structural strength of a double housing arrangement but without taking up as much space and requiring fewer assembly steps. This results in an axial flux machine with smaller outer dimensions that is cheaper and quicker to manufacture.

Further, responsive to the heating and subsequent cooling during the injection moulding process, the outer metal ring and the inner polymer ring shrink to different extents due to their different material properties. Specifically, the polymer, for example a 35% glass reinforced polyamide resin heated to e.g. around 300-350° C., e.g. around 325° C. during the injection moulding process shrinks up to 2-3 times more than the metal, for example aluminium heated to around 150° C. during the injection moulding process. To inhibit the inner polymer ring pulling away from the metal outer ring as it shrinks, the polymer inner ring comprises a gripping surface shaped to grip a portion of the metal outer ring, for example by clamping onto an upper and/or lower surface of an inwards formation of the inner surface of the outer ring. As the metal and polymer cool, the polymer shrinks more than the metal, tightening its grip and clamping downwards and inwards on the metal outer ring, more specifically on a formation on the metal outer ring as described later. This secures the polymer inner ring to the metal outer ring during the injection moulding process without requiring additional assembly steps such as, for example, bolting the polymer to the metal.

This is also useful after the machine has been manufactured as some applications for the technology include use over a wide temperature range e.g. up to +50° C. or down to −40° C. Clamping of this type can provide a firm connection between the polymer and the metal as well as positional stability, over large temperature ranges.

Surprisingly, the strength of the attachment of the polymer inner ring to the metal outer and the positional stability of the polymer inner ring relative to the metal outer ring is found to be significantly increased compared to other methods of securing polymer to the metal such as bolting. As a result, manufacturing tolerances during assembly of the axial flux machine that depend on accurate positioning, and thus a high positional stability of the polymer inner ring of the stator housing, are improved by using the method of the present disclosure.

Thus the injection moulding may comprise a step of cooling the metal outer ring and the polymer inner ring after the polymer resin has been injected and the polymer inner lining has formed. As described above, this causes the gripping surface of the inner ring to shrink relatively to the gripped portion of the outer ring, causing an increase in the gripping force and a corresponding increase in strength of the attachment of the polymer inner ring to the metal outer ring and positional stability of the polymer inner ring relative to the metal outer ring.

In implementations, a formation is provided on an inner wall of the outer ring. As the gripping surface shrinks axially and radially, it clamps down more strongly onto the formation on the inner wall of the outer ring and also applies a radially inwards, tensioning force, pulling radially inwards on the formation. Given the symmetrical circular shape of the inner and outer rings, these forces are applied equally and symmetrically around the circumferences of the rings, pulling and tightening the polymer inner ring tightly in position relative to the metal outer ring, thereby increasing the positional stability of the inner ring relative to the outer ring.

In some implementations the formation comprises a raised portion, raised above an inner surface of the metal outer ring. The formation extends circumferentially around the inner surface, though not necessarily continuously.

In implementations the formation has two edges. In implementations each edge has an overhang to lock the polymer inner ring onto the metal outer ring. In some implementations the two edges of the formation may be circumferential edges, that is running around the metal outer ring in a circumferential direction e.g. one edge towards each edge of the metal outer ring, e.g. parallel to one another. In some implementations the two edges of the formation may be axial edges i.e. edges extending in an axial direction of the metal ring (perpendicular to the circumferential direction) e.g. parallel to the axial direction. In this case the formations may be generally square or rectangular. In such implementations the formation may have four overhanging edges to lock the polymer inner ring onto the metal outer ring.

In implementations the raised portion has a recess under an edge of the raised portion defining the overhang. An inner part of the recess may be curved, and an outer edge of the raised portion may be curved, such that there is a smooth transition from the inner surface of the metal outer ring to an upper surface of the raised portion of the formation. Advantageously, this shape ensures there are no sharp, circumferential edges on the metal outer ring thereby reducing stresses in the polymer inner ring as it shrinks onto the formation during cooling, whilst nonetheless holding the polymer inner ring securely to the metal. Further, by ensuring there are no sharp edges, the polymer resin melt flows more smoothly during the injection moulding process.

In some implementations the injection moulding comprises forming the gripping surface of the polymer inner ring around a formation on an inner surface of the metal outer ring. Forming the polymer inner ring around the formation may be achieved by, for example, outsert injection moulding where the metal outer ring is used as at least part of an outsert mould, i.e. where the metal outer ring functions as an outer wall of the mould of the injection moulding machine. The polymer resin melt is accordingly injected into the injection moulding chamber against the metal outer ring having a formation thereon, thereby forming a shape around the formation on the inner surface of the metal outer ring.

By forming the polymer inner ring using the metal outer ring as an outsert mould the formation of ports into the otherwise hermetically sealed cavity in which the stator is housed may be facilitated. Specifically, the metal outer ring may be provided with one or more ports from an outer surface to the inner surface. A suitable insert may be provided during the injection moulding process to form a self-aligned, corresponding port through the polymer inner ring. Once the injection moulding is complete there is no further need to separately align the port in the outer ring with the port in the inner ring. Such ports may be used, for example, to provide ports for coolant entry and exit, sensor ports, electrical power ports e.g. inverter interface ports, inspection ports, ports for busbar connections, and the like. Thus the injection moulding may comprise, with an insert, forming a port in the polymer inner ring arranged in alignment with a corresponding port in the metal outer ring.

One or more outer openings of the ports may be provided by one or more seals such as O-rings to ensure a hermetic seal to any pipes, cables or other components inserted therein. For example, a first seal may be provided to seal around the polymer part of the port to inhibit any coolant, such as oil, escaping from the otherwise hermetically sealed chamber. A second seal may be provided to seal around the metal part of the port to inhibit water and dirt from getting into the region enclosing the rotor and the stator housing.

As previously described, the increased positional stability of the polymer inner ring allows for improved component tolerances that depend on accurate positioning of the polymer inner ring relative to the metal outer ring, or to other components of the stator housing, or to the machine itself, for example one or more of the rotors. One such component whose positioning must, in implementations, be accurate is the end wall plate which is, for example, a polymer end wall plate. This is particularly so where shoes (which fit against ends of the stator bars) are mounted on and held in place by this end wall plate during manufacture.

End wall plates may be secured to the upper and/or lower surfaces of the polymer inner ring to hermetically seal the stator inside the stator housing apart from the above-described one or more ports. The end wall plate(s) may be secured by laser welding to one or more ribs on the upper and/or lower surfaces of the polymer inner ring. A limiting factor of the accuracy of the laser welding process is the positioning and positional stability of these one or more ribs, whose positioning and stability in turn depend on the positioning and positional stability of the polymer inner ring relative to the metal outer ring. The increased positional stability of the polymer inner ring provided by the present disclosure can accordingly greatly enhance the accuracy of the laser welding process used to secure the end wall plates to the polymer inner ring.

Thus in some implementations the injection moulding comprises forming a rib on an upper and/or on a lower surface of the polymer inner ring, for example by providing a mould having a corresponding rib shape thereon against which the polymer resin is injected. The one or more ribs may extend circumferentially around the upper and/or lower surface of the polymer inner ring and provide a surface suitable for use with a laser welding process.

In some implementations manufacturing the housing comprises laser welding an end wall plate to the rib. For example, one or more end wall plates may be laser welded to the one or more ribs on the upper and/or lower surfaces of the polymer inner ring, to enclose the stator therein to provide the desired hermetic sealing provided by the polymer material. The end wall plates may be, for example, of metal or polymer. As a result of the increased positional stability of the polymer inner ring relative to the metal outer ring, the positional stability of the rib for laser welding is also improved, allowing the end wall plates to be positioned and secured more accurately to the polymer inner ring than with some existing methods. The accurate positioning of the end wall plates in this way improves acceptable manufacturing tolerance levels for all other components of the axial flux machine that depend on the positioning of the end wall plates. For example, one such feature that may have very tight tolerances during manufacturing are the shoes on the end of each stator bar. As previously described the end wall plates may mount the shoes of the stator bar in a manner that depends on highly accurate positioning. By improving the accurate positioning of the end wall plates resulting from the increased positional stability of the polymer inner ring, the positioning of the shoes mounted on the end wall plates may also be made more accurate. Thus in implementations an end of a stator bar is provided with a shoe, and the end wall plate mounts the shoe, The polymer inner ring formed according to the present disclosure also need not be as thick in a radial direction as walls of the polymer parts of existing double housings arrangements. For example, the radial thickness of the walls of a polymer housing in a double housing arrangement is typically required to be of the order of 10 mm thick or greater to provide a desirable positional stability and structural strength to allow the polymer housing to be bolted to the aluminium housing. Any thinner and the polymer may buckle under the forces applied by bolting to an aluminium housing and/or the forces resulting from the torque during operation of the machine.

In contrast, the radial thickness of the polymer inner ring of the present disclosure which grips the metal outer ring may be between 0.1-5.0 mm, e.g. between 1.0-3.0 mm, 1.5-3.0 mm or 2.0-3.0 mm. Using a thickness of greater than 1.5 mm or 2.0 mm facilitates the polymer flowing without freezing; using a thickness of less than 3 mm facilitates freezing without voids thereafter. The reduced thickness is in part enabled because the polymer need not be as strong as it obtains structural strength form the metal outer housing it is moulded to, and it need not have the strength to support bolting structures suitable for bolting to an aluminium housing as is otherwise required for a double housing arrangement.

Where even greater positional stability levels or grip are desired the inner surface of the metal inner ring may be treated with a corona treatment process. By pre-treating the inner surface of the metal outer ring in this way, the strength of the join between polymer inner ring and the metal outer ring, and thus the positional stability and grip of the polymer inner ring, may be further improved. Specifically, not only is the polymer gripped or clamped to the metal of the metal outer ring, but the corona treatment allows the surface of the polymer to chemically bond to the surface of the metal, further improving the strength of the join between the inner and outer rings. The corona treatment may comprise, for example, applying a corona discharge plasma to the inner surface of the metal outer ring.

Synergistically the above-described reduced polymer thicknesses can reduce internal stress the polymer inner ring is subject to as the polymer inner ring shrinks and tries to pull away from the metal surface. A thicker layer of polymer can be subject to higher internal stress than a thinner layer of polymer in this situation (there is more polymer to shrink). Thus a firm grip between the polymer and the metal, which may include corona treatment as described, may facilitate a reduction in internal stress.

In some implementations, e.g. where the axial flux permanent magnet machine comprises a rotor on each side of the stator, a metal cover may be attached to one or each side of the metal outer ring, for example on the upper and lower surfaces thereof to enclose each rotor between the cover and the outer surface of the end wall plate. Advantageously, this provides a complete metal outer shell made up of the metal outer ring and the metal covers. Metal may thereby enclose a complete polymer inner shell made up of the polymer end wall plates and the polymer inner ring. Thus a double housing arrangement may be provided having structural strength and hermetic sealing without the disadvantages of high space requirements, high assembly cost and assembly time.

In some implementations the metal outer ring, and where present the metal cover(s), comprise aluminium and/or an alloy thereof. In some implementations the polymer resin comprises a glass-reinforced polyamide resin, e.g. 35% glass-reinforced polyamide resin such as the Zytel™ HTN 51G35 by DuPont™ Materials.

In a further aspect there is provided an axial flux (permanent magnet) machine. The machine has a stator comprising a set of coils wound on respective stator bars and disposed circumferentially at intervals about an axis of the machine, and a rotor bearing a set of permanent magnets and mounted for rotation about the axis. The rotor and stator are spaced apart along the axis to define a gap there between in which magnetic flux in the machine is generally in an axial direction. The machine includes a stator housing comprises a metal outer ring and a polymer inner ring lining an inner surface of the metal outer ring. The polymer inner ring may have a gripping surface arranged to grip a portion of the metal outer ring.

As described above, an inner surface of the metal ring may comprise a formation around which the gripping surface is formed as part of an injection moulding process. The gripping surface mates with the formation, and may therefore provide the above-described increase in positional stability of the polymer inner ring relative to the metal outer ring compared to existing double housing arrangements. The formation may have one or more features as previously described.

As described above, the stator housing may comprise respective plates secured to an upper and a lower surface of the polymer inner ring, which may facilitate the desired hermetically sealed properties of the stator housing.

As described above, the axial flux permanent magnet machine may be a yokeless and segmented armature machine having a pair of rotors, one to either side of the stator.

The housing may define a chamber for coolant for coils of the stator. End plates may hold the stator bars in position during operation of the machine.

An axial flux permanent magnet machine as described above, and as used in the above-described methods, may be a motor or a generator.

### BRIEF DESCRIPTION OF THE DRAWINGS

These and other aspects of the invention will now be further described, by way of example only, with reference to the accompanying figures in which:

FIGS. 1a to 1c show, respectively, a general configuration of a two-rotor axial flux machine, example topologies for axial permanent magnet machines including a schematic side view of a yokeless and segmented armature (YASA) machine, and an enumerated drawing of a YASA machine.

FIG. 2 shows a perspective view of the YASA machine of FIG. 1c.

FIG. 3 shows a perspective exploded view of a stator and stator housing for a YASA machine.

FIG. 4a shows an exploded perspective view of a cylindrical wall of a stator housing of an axial flux permanent magnet machine according to an embodiment.

FIG. 4b shows a perspective view of a polymer inner ring of the cylindrical wall of FIG. 4a.

FIG. 4c shows a zoomed in view of the polymer inner ring of FIG. 4c.

FIG. 5a shows a cross section of part of a cylindrical wall of a stator housing of an axial flux permanent magnet machine illustrating a step of a method according to an embodiment.

FIG. 5b shows a cross section of part of a cylindrical wall of a stator housing of an axial flux permanent magnet machine illustrating a step of a method according to an embodiment.

FIG. 5c shows a cross section of part of a cylindrical wall of a stator housing of an axial flux permanent magnet machine illustrating a step of a method according to an embodiment.

FIG. 5d shows a cross section of part of a cylindrical wall of a stator housing of an axial flux permanent magnet machine illustrating a step of a method according to an embodiment.

FIG. 5e shows a cross section of part of a cylindrical wall of a stator housing of an axial flux permanent magnet machine illustrating a step of a method according to an embodiment.

FIG. 6a shows a portion of a cylindrical wall of a stator housing of an axial flux permanent magnet machine illustrating retention features.

FIG. 6b shows a cross section of part of a cylindrical wall of a stator housing of an axial flux permanent magnet machine having retention features illustrated in FIG. 6a, illustrating a step of a method according to an embodiment.

Like elements are indicated by like reference numerals.

### DETAILED DESCRIPTION

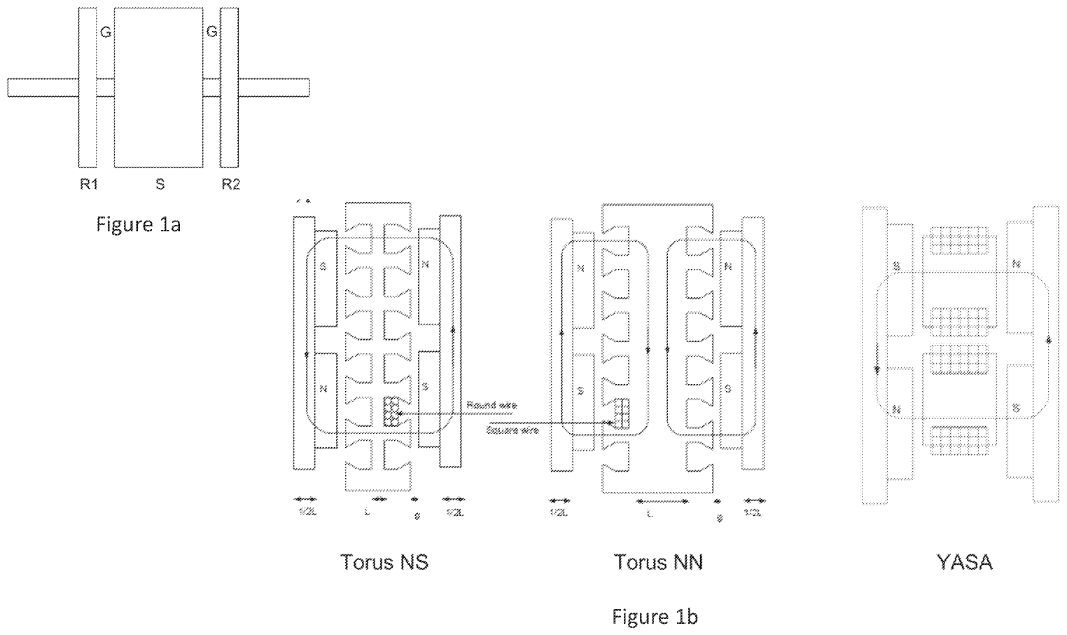

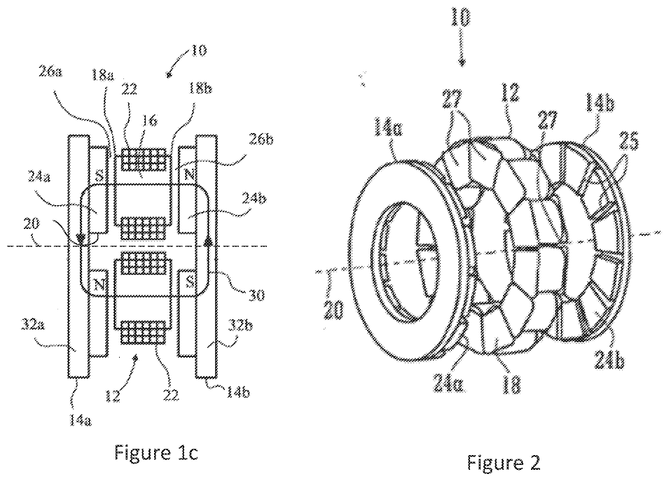

FIGS. 1c, 2 and 3, which are taken from WO2012/022974, 1c show details of an example yokeless and segmented armature (YASA) machine 10. The machine 10 may function either as a motor or as a generator.

The machine 10 comprises a stator 12 and, in this example, two rotors 14a,b. The stator 12 comprises a collection of separate stator bars 16 spaced circumferentially about a machine axis 20, which also defines an axis of the rotors 14a,b. Each bar 16 carries a stator coil 22, and has an axis which is typically disposed parallel to the rotation axis 20. Each end 18a,b of the stator bar is provided with a shoe 27, which helps to confine coils of the stator coil 22 and may also spread the magnetic field generated by the stator coil. The stator coil 22 may be formed from square or rectangular section insulated wire so that a high fill factor can be achieved. In a motor the stator coils 22 are connected to an electrical circuit (not shown) that energizes the coils so that poles of the magnetic fields generated by currents flowing in the stator coils are opposite in adjacent stator coils 22.

The two rotors 14a,b carry permanent magnets 24a,b that face one another with the stator coil 22 between. When the stator bars are inclined (not as shown) the magnets are likewise inclined. Gaps 26a,b are present between respective shoe and magnet pairs 17/24a, 27/24b. In an example motor the stator coils 22 are energized so that their polarity alternates to cause coils at different times to align with different magnet pairs, resulting in torque being applied between the rotor and the stator. As described above, the housing must accordingly be structurally strong enough to withstand the forces thereon resulting from the torque between the rotor and stator. In FIGS. 1c, 2 and 3, the structural strength of the stator housing is achieved by providing a suitably thick layer of polymer, for example greater than 10 mm and bolting the polymer to an aluminium outer housing.

The rotors 14a,b are generally connected together, for example by a shaft (not shown), and rotate together about the machine axis 20 relative to the stator 12. In the illustrated example a magnetic circuit 30 is formed by two adjacent stator bars 16, two magnet pairs 24a,b, and two back plates 32a,b, one for each rotor, linking the flux between the backs of each magnet pair 24a,b facing away from the respective coils 22. The back plates 32a,b may be referred to as back irons and comprise a magnetic material, typically a ferromagnetic material although not necessarily iron. This magnetic material is not required to be a permanent magnet. The stator coils 16 are enclosed within a housing which defines a chamber for the rotors and stator, and which may be supplied with a cooling medium.

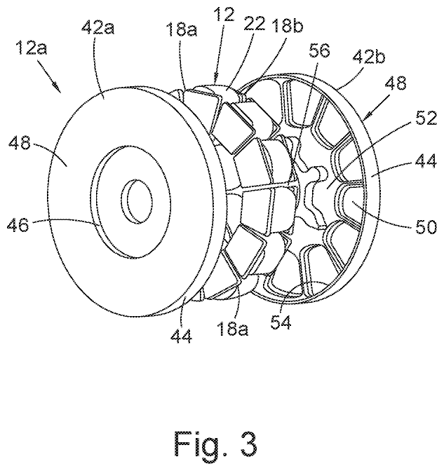

FIG. 3 shows a stator 12a in which the stator coils are located between plastics material clam shells 42a,b. These clamshells have external cylindrical walls 44, internal cylindrical walls 46, and annular end walls 48. In FIG. 3 the end walls 48 include internal pockets 50 to receive the shoes 18a,b of the stator bars 16 and serve to locate the stator coil assemblies 16, 22, 18a,b when the two clam shell housings 42a,b of the stator 12a are assembled together. The stator housing 42a,b defines spaces 52 internally of the coils 22 and externally at 54 around the outside of the coils 22, and there are spaces 56 between the coils. The spaces 52, 54, 56 are interlinked defining a cooling chamber. Although not shown in FIG. 3, when assembled the stator housing 42a,b is provided with ports that allow cooling medium such as oil to be pumped into the spaces 52, 54, 56 to circulate around the coils and cool them.

The coil cores may be laminated with the inter-lamination insulation parallel to the desired flux direction. However the coil cores may also be formed from soft-iron particles coated with electrical insulation and moulded to a desired shape (soft magnetic composites—SMC), being bound together by the insulation matrix. An example SMC may comprise glass-bonded iron particles, a thin layer (typically <10 μm) of glass bonding and mutually electrically insulating the iron particles, leaving some residual porosity. The shoes 27 may be moulded from SMC, e.g. using a high-temperature, high-pressure compaction process. Conveniently the shoes and stator bar may be formed separately and subsequently assembled.

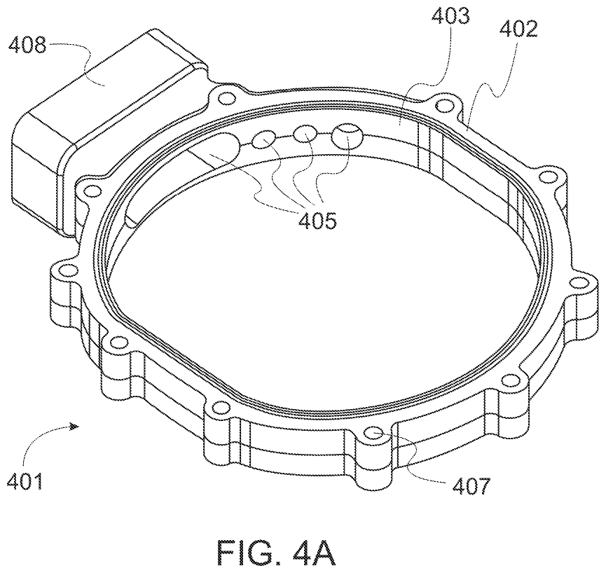

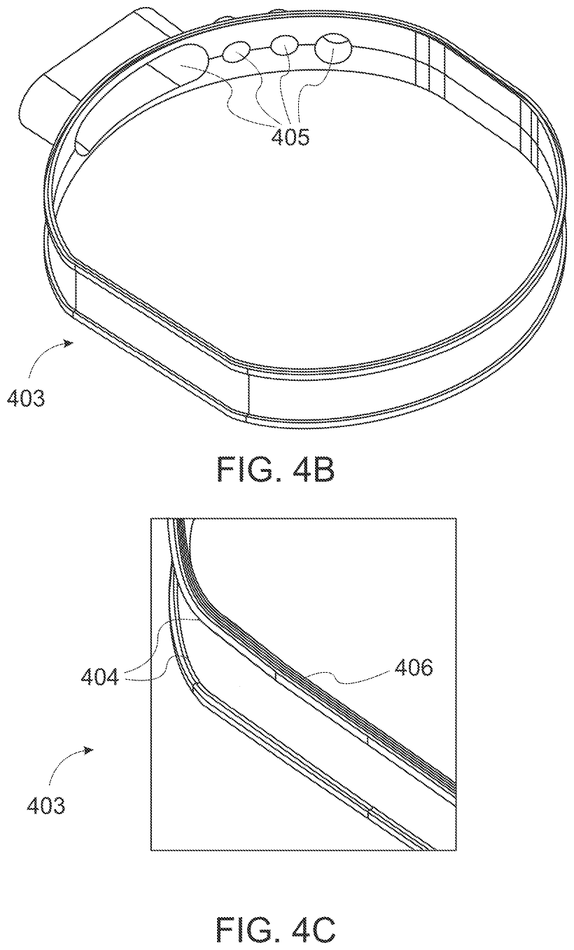

FIGS. 4a, 4b and 4c respectively show an exploded perspective view of a cylindrical wall 401 of a stator housing of an axial flux machine according to an embodiment, a perspective view of a polymer inner ring 403 of the wall 401 according to an embodiment, and a zoomed in view of the polymer inner ring 403 showing a gripping surface 404 of the polymer inner ring 403 according to an embodiment.

The generally cylindrical wall 401 comprises a metal outer ring 402 lined with a polymer inner ring 403. The polymer inner ring 403 comprises a gripping surface 404 arranged to grip a portion of the metal outer ring 402. The cylindrical wall 401 comprises a number of ports 405, for example a port for an inverter interface, sealed inspection holes for busbar connections, sensor ports, and coolant ports for circulating coolant around the inside of the stator housing.

An upper and/or lower surface of the inner polymer ring is provided with one or more ribs 406 configured for receiving an end wall plate (not shown) thereon and for being securely laser welded to said end wall plate to provide a hermetically sealed chamber (apart from the ports) defined by the wall 401 and the end wall plates. The metal outer ring 402 is provided with a plurality of bolt holes 407 for bolting the cylindrical wall 401 to one or more other components of the axial flux machine, for example to an axial flux machine mount. The metal outer ring 402 is further provided with an electronics interface housing 408 for housing an interface to electronics of the axial flux machine, for example an inverter interface and/or one or more busbars. The gripping surface 404 of the polymer inner ring 403 clamps down onto a formation of the metal outer ring 402.

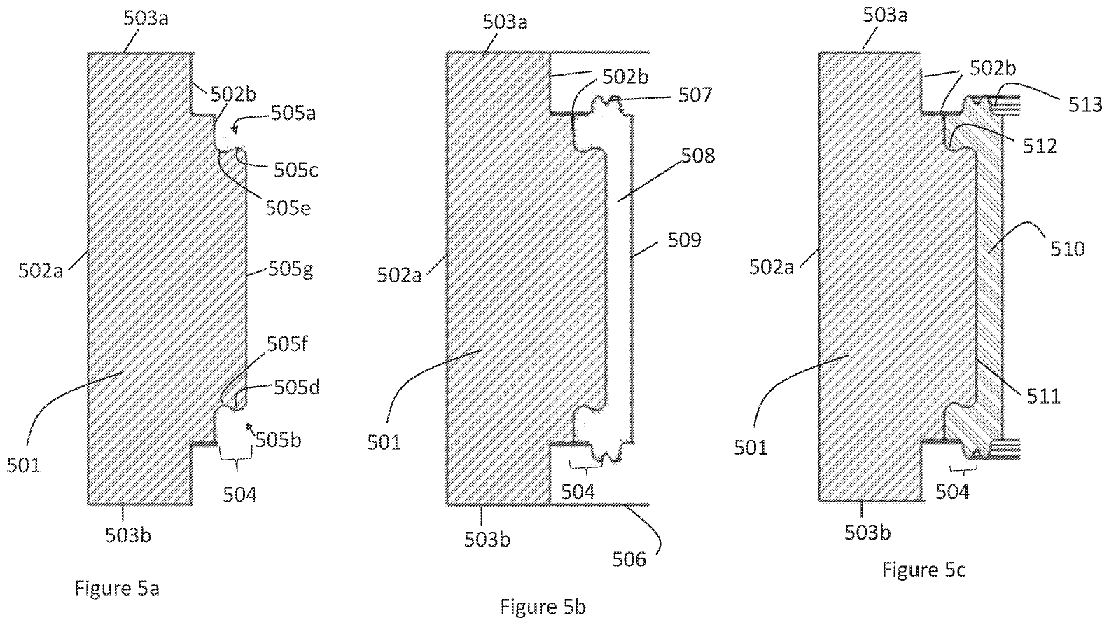

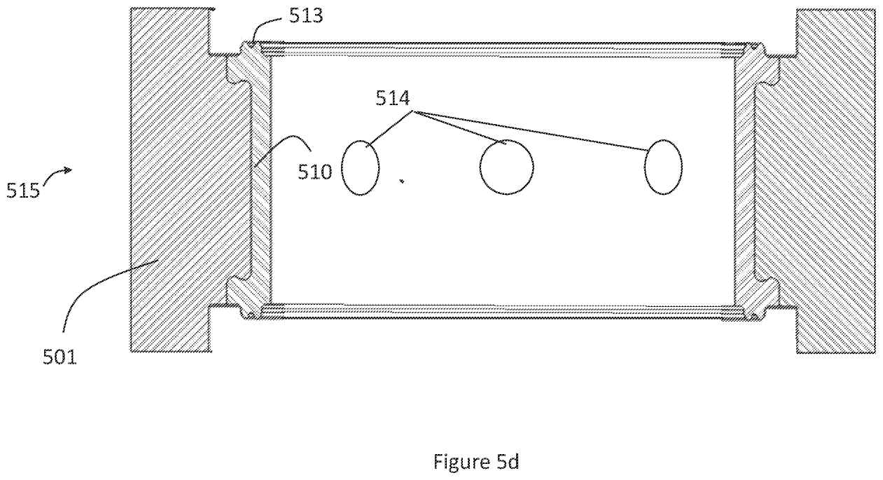

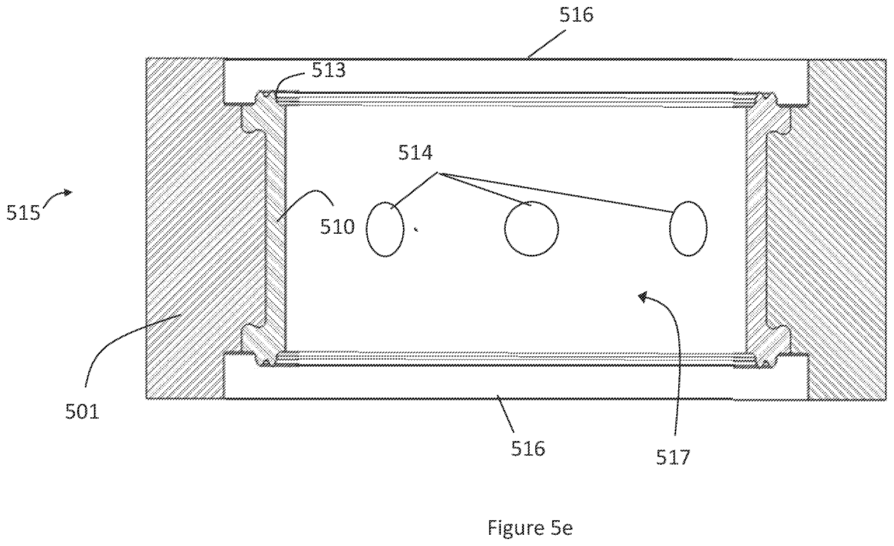

FIGS. 5a, 5b, 5c, 5d and 5e respectively illustrate steps of a method for manufacturing a housing for the stator of an axial flux machine according to an embodiment, the housing having a generally cylindrical wall comprising a metal outer ring lined with a polymer inner ring.

In FIG. 5a, a cross section of part of a cylindrical metal outer ring 501, for example an aluminium outer ring, is shown. The metal outer ring 501 comprises an outer surface 502a, an inner surface 502b, an upper surface 503a and a lower surface 503b. The inner surface 502b comprises a formation 504. The formation 504 comprises a raised portion raised above an inner surface 502b of the metal outer ring 501, wherein the formation extends circumferentially (not necessarily continuously, though this may be preferred) around the inner surface 502b of the metal outer ring. The formation 504 has two edges 505a, 505b, one towards each of the edges of the metal outer ring and being approximately parallel thereto.

Each edge 505a, 505b has an overhang 505c, 505d to lock the polymer inner ring onto the metal outer ring 501. The raised portion has a recess 505e, 505f under an edge of the raised portion defining the overhang 505c, 505d. An inner part of the recess 505e, 505f is curved such that there is a smooth transition from the inner surface of the outer metal ring to an upper surface 505g of the raised portion of the formation 504. As previously described this ensures there are no sharp circumferential edges, resulting in less stress in the polymer, improved polymer resin melt flows, and better shrinkage onto the formation 504. As described above, a corona treatment may be applied to the metal outer ring 501 prior to or after positioning in the injection moulding machine.

In FIG. 5b, the metal outer ring 501 is positioned in an injection moulding machine. In positioning the metal outer ring 501 in the injection moulding machine, the metal outer ring 501 is used as an outsert, for example used as one of the walls of a mould 506 having a space 508 therein into which polymer resin may be injected. The polymer resin may be, for example, a 35% glass reinforced polyamide resin such as Zytel™ HTN 51G35 by DuPont™ materials although other polymer resins may be used. Typically the polymer resin has a higher temperature dependent rate of shrinkage than the metal of the metal outer ring e.g. aluminium.

One or more upper surfaces of the formation 504 of the metal outer ring 501 may be shaped to engage with one or more other walls of the mould 506, thereby sealing against them prior to the injection moulding process.

The mould 506 may be provided with rib-shaped structures 507 thereon. Thus, the ring-like space 508 into which polymer resin is to be injected may be defined by the protrusion 504, the rib-shaped structures 507 and an inner wall 509 of the mould 506. The injection moulding process is then performed and a polymer resin is injected into the space 508, thereby fabricating a polymer inner ring 510 on the metal outer ring 501.

As part of the injection moulding process, the polymer resin melt may be heated to around 300-350° C., e.g. around 325° C., and injected under a maximum pressure of e.g. around 155-205 MPa, e.g. 180 MPa, with an injection moulding machine, into the mould 506 over around e.g. 1-3 seconds, e.g. 2 seconds, using the metal outer ring 501 as an outsert, held at e.g. around 125-175° C., e.g. 150° C. Once injected, the polymer resin is left to pack into the mould 506 under a maximum pressure of e.g. around 125-175 MPa, e.g. 150 MPa to allow air bubbles to vent over around e.g. 10-30 seconds, e.g. 20 seconds.

The polymer resin melt fills the space 508 forming a shape defined by the formation 504, rib-like structures 507 and the inner surface 509 of the mould 506, thus forming the polymer inner ring 510 having a gripping surface 511 around the formation 504 of the metal outer ring 501. As the polymer resin melt fills around the raised portion of the formation 504, portion 512 of the gripping surface 511 flows around raised portion and curves back onto itself resulting in an engagement between the gripping surface 511 and the formation 504 without any sharp edges therebetween.

The polymer resin melt is then allowed to cool over e.g. around 10-30 seconds, e.g. around 18 seconds until the temperature is e.g. around 205-255° C., e.g. 230° C. As described above, it is during the cooling that the gripping surface 511 of the polymer inner ring 510 shrinks to a greater extent than the metal outer ring 501, thereby causing it to grip the metal outer ring 501. In particular, the cooling causes shrinking not only in a radially inwards direction but also in a direction parallel to the central axis of the cylindrical ring. Accordingly, the gripping surface 511 has shrinkage having both a horizontal and vertical component relative to the central axis of the cylindrical ring. The portion 512 of the gripping surface 511 that formed around the raised portion of the formation 504 thus clamps down onto the raised portion and also pulls it radially inwards as it cools, thereby providing a stronger and more positionally stable securing of the polymer inner ring 501 to the metal outer ring 510 with less structural stress than would be possible without the raised portion. For example, the polymer inner ring 510 is more securely attached to the metal outer ring 501 and with less structural stress than if the formation 504 had perfectly flat surfaces and sharp corners and/or edges. As described above, when the polymer resin melt fills the rib-shaped structures 507, the polymer inner ring 510 is provided with ribs 513 for subsequent securing of end plates to said ribs with, for example, laser welding.

In FIG. 5c, once the polymer resin is cooled to e.g. around 205-255° C., e.g. 230° C., the mould 506 is opened over e.g. around 5 seconds, and the injection moulded polymer inner ring 510 and the corresponding metal outer ring 501 against which the polymer resin melt has been injected is ejected from the injection moulding machine. Once ejected, the polymer inner ring 510 fabricated on the metal outer ring 501 is allowed to cool further to room temperature, for example e.g. around 25° C. This cooling may be performed in a controlled environment to control the cooling profile and time or may occur naturally without any specific cooling profile.

FIG. 5d shows a cut away view of the cylindrical wall 515 of the stator housing after the injection moulding process is complete. The cylindrical wall 515 in FIG. 5d is similar to the cylindrical wall 401 shown in FIG. 4a. In the view of FIG. 5d, the polymer inner ring 510 is shown in a plane into the page to illustrate that one or more ports 514 may be provided thereon, for example, a port for an inverter interface, sealed inspection holes for busbar connections, sensor ports, and coolant ports for circulating coolant around the inside of the stator housing in a similar manner to in FIG. 4a. The ribs 513 are provided in a continuous circumferential manner around the upper and lower surfaces of the polymer inner ring 510.

In FIG. 5e, the manufacture of the stator housing is continued by laser welding respective end wall plates 516 to the ribs 513 on the upper and lower surfaces of the polymer inner ring 510 cylindrical wall 515 of the stator housing to hermetically seal (apart from the ports) a chamber 517 between the polymer inner ring 510 and the inner surfaces of the end wall plates 516. As shown in FIG. 5e, in laser welding the ribs 513 to the polymer inner ring 510 the outer surfaces of the end wall plates 516 may be made flush with the upper surface of the metal outer ring 501 to provide a more vertically compact stator housing than would be possible had bolting of the polymer to the metal been required.

Whilst not shown, where the axial flux permanent magnet machine comprises two rotors, one on each side of the stator, a further step may be performed in manufacturing the housing of the stator. This may comprise attaching a metal cover to each side of the metal outer ring, the metal cover enclosing the housing for the stator and also the rotors. As described above this can provide a complete metal outer shell made up of the metal outer ring and the metal covers enclosing a complete polymer inner shell made up of the polymer end wall plates and the polymer inner ring. Thus, a double housing arrangement is provided having advantageous structural strength and hermetic sealing without the disadvantages of high space requirements, high assembly cost and assembly time.

Whilst not shown, each end of each stator bar may be provided with a shoe and the end wall plates may be configured to mount the shoes during assembly of the axial flux permanent magnet machine. For example the end wall plate may have recesses in which the shoes may be supported or fastened. As described above, the assembly steps of mounting the shoes in the end wall plate have very tight manufacturing tolerances and require accurate positioning of the end wall plates. This in turn depends on accurate positioning and positional stability of the inner polymer ring onto which the end wall plates are secured. The methods described herein, and the axial permanent magnet machine assembled therewith, can ensure that the mounting of the shoes is accurate.

Optionally the end wall plates may be provided with an opening in their central axis, for example to allow a component such as an axle of the axial flux machine to pass through. For example the stator housing may have a generally toroidal shape with an inner wall (not shown).

In some other implementations different configurations of the formation on the inner surface of the metal outer ring may be used. For example, the formation on the inner surface of the metal outer ring need not be a single, circumferentially continuous formation and may instead comprise a plurality of formations spaced apart along the inner surface.

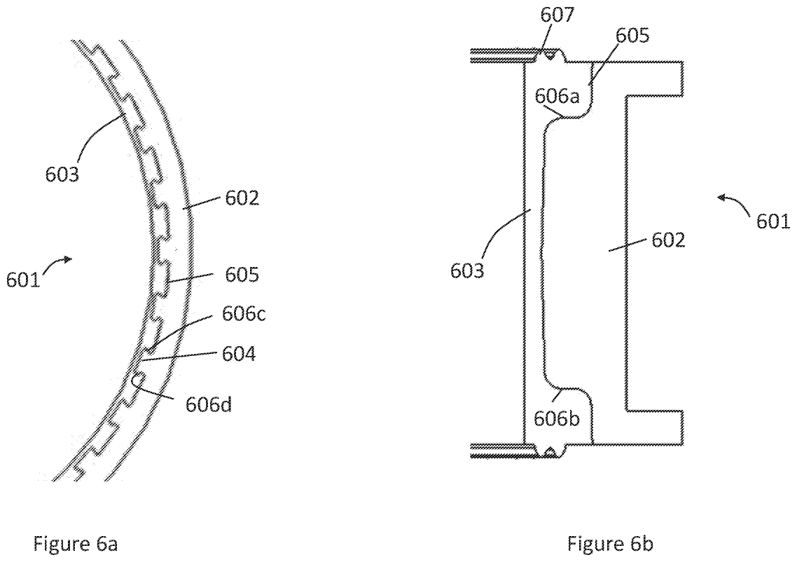

FIGS. 6a and 6b show cross-sectional views of a portion of a cylindrical wall 601 of a stator housing. In the same way as the formation on the metal outer ring 602 described above, each of the plurality of formations 604 comprises a raised portion raised above an inner surface 605 of the metal outer ring 602 and in this case has four edges, one 606a, 606b towards each edge of the metal outer ring 602 and now also one edge 606c, 606d in each circumferential direction along the inner surface 605 of the metal outer ring 602.

Different to the formation described above, it is the edges 606c, 606d in the circumferential directions that have an overhang to lock the polymer inner ring 603 onto the metal outer ring 602. The raised portion thus has a recess under an edge 606c, 606d of the raised portion defining the overhang. As with the continuous formation, an inner part of the recess is curved and an outer edge of the raised portion (for example all the edges 606a, 606b, 606d, 606d) of the formation 604 is curved, such that there is a smooth transition from the inner surface 605 of the outer metal ring to an upper surface of the raised portion of the formation 604.

This implementation of the formation 604 has the same advantages as the earlier implementation of the formation described herein. The plurality of formations 604 on the inner surface 605 of the metal outer ring 602 may be manufactured by, for example cutting out recesses on the inner surface of the metal outer ring, leaving a formation 604 between each of the cut outs. Thus, when the injection moulding process is performed, the polymer resin melt flows, for example axially, into the space left by the cut outs around the formations 604, and in the same manner as described above, locks the polymer inner ring 603 onto the metal outer ring 602 as it cools. The inner polymer ring 603 is also provided with ribs 607 in the same manner as the other implementations thereof described herein.

The terms upper and lower surface, and the horizontal and vertical directions as used herein are used to describe the relative positioning of said surfaces and directions relative to each other and are not intended to limit the present disclosure to any given orientation in a coordinate system. The terms upper and lower, and horizontal and vertical are used for convenience of illustration relative to the figures provided herein. Thus, the upper surface is on an opposite side of a feature to the lower surface. Similarly, the inner surface is on an opposite of a feature to the outer surface regardless of the orientation of the feature in the coordinate system.

No doubt many other effective alternatives will occur to the skilled person. It will be understood that the invention is not limited to the described embodiments and encompasses modifications apparent to those skilled in the art lying within the scope of the claims appended hereto.

1. A method of manufacturing a housing for the stator of an axial flux permanent magnet machine, the machine having a stator comprising a set of coils wound on respective stator bars and disposed circumferentially at intervals about an axis of the machine, and a rotor bearing a set of permanent magnets and mounted for rotation about the axis, and wherein the rotor and stator are spaced apart along the axis to define a gap therebetween in which magnetic flux in the machine is generally in an axial direction, the housing having a cylindrical wall comprising a metal outer ring lined with a polymer inner ring,
the method comprising:
positioning the metal outer ring in an injection moulding machine;
with the injection moulding machine, injection moulding a polymer resin onto an inner surface of the metal outer ring to fabricate the polymer inner ring, the polymer inner ring comprising a gripping surface arranged to grip a portion of the metal outer ring; and
manufacturing said housing using the metal outer ring and the polymer inner ring.

2. The method of claim 1, wherein the injection moulding comprises cooling the metal outer ring and the polymer inner ring to shrink the gripping surface of the polymer inner ring relative to the gripped portion of the metal outer ring to secure the polymer inner ring to the metal outer ring.

3. The method of claim 1, wherein the injection moulding comprises forming the gripping surface around a formation on an inner surface of the metal outer ring.

4. The method of claim 3, wherein the formation comprises a raised portion raised above an inner surface of the metal outer ring, wherein the formation extends circumferentially around the inner surface, wherein the formation has two edges, and wherein each edge has an overhang to lock the polymer inner ring onto the metal outer ring.

5. The method of claim 4, wherein the raised portion has a recess under an edge of the raised portion defining the overhang, and wherein an inner part of the recess is curved and an outer edge of the raised portion of the formation is curved, such that there is a smooth transition from the inner surface of the outer metal ring to an upper surface of the raised portion of the formation.

6. The method of claim 1, wherein the injection moulding comprises outsert injection moulding using the metal outer ring as an outsert mould.

7. The method of claim 1, wherein the injection moulding comprises, with an insert, forming a port in the polymer inner ring arranged in alignment with a corresponding port in the metal outer ring.

8. The method of claim 1, wherein the injection moulding comprises forming a rib on an upper and/or on a lower surface of the polymer inner ring.

9. The method of claim 8, further comprising laser welding respective end wall plates to the rib on the upper and lower surface of the polymer inner ring to hermetically seal a chamber between the polymer inner ring and the respective end wall plates.

10. The method of claim 1, wherein each end of each stator bar is provided with a shoe, and wherein the end wall plates mount the shoes.

11. The method of claim 1, wherein a radial thickness of the polymer inner ring is between 1.5 mm and 3.0 mm.

12. The method of claim 1, comprising:
applying a corona treatment to the inner surface of the metal outer ring before fabricating the polymer inner ring thereon.

13. The method of claim 1 wherein the axial flux permanent magnet machine comprises two rotors, one on each side of the stator, the method further comprising attaching a metal cover to each side of the metal outer ring, wherein the metal covers cover the housing for the stator and also the rotors.

14. The method of claim 1 wherein the polymer resin comprises a glass-reinforced polyamide resin.

15. The method of claim 9, wherein the machine is a yokeless and segmented armature machine having a pair of the rotors, one to either side of the stator, wherein the housing defines a chamber for coolant for the coils of the stator, and wherein the end plates hold the stator bars in position during operation of the machine.

16. An axial flux permanent magnet machine comprising:
a stator comprising a set of coils wound on respective stator bars and disposed circumferentially at intervals about an axis of the machine;
a rotor bearing a set of permanent magnets and mounted for rotation about said axis, wherein said rotor and stator are spaced apart along the axis to define a gap therebetween in which magnetic flux in the machine is generally in an axial direction; and
a stator housing;
wherein the stator housing comprises a metal outer ring and a polymer inner ring lining an inner surface of the metal outer ring, and
wherein the polymer inner ring comprises a gripping surface arranged to grip a portion of the metal outer ring.

17. The axial flux permanent magnet machine of claim 16, wherein the gripped portion of the metal outer ring comprises a formation on an inner surface of the metal outer ring.

18. The axial flux permanent magnet machine of claim 17, wherein the formation comprises a raised portion raised above an inner surface of the metal outer ring, wherein the formation extends circumferentially around the inner surface, wherein the formation has two edges, and wherein each edge has an overhang to lock the polymer inner ring onto the metal outer ring.

19. The axial flux permanent magnet machine of claim 18, wherein the raised portion has a recess under an edge of the raised portion defining the overhang, wherein an inner part of the recess is curved and an outer edge of the raised portion of the formation is curved such that there is a smooth transition from the inner surface of the outer metal ring to an upper surface of the raised portion of the formation.

20. The axial flux permanent magnet machine of claim 16, wherein the stator housing comprises respective end wall plates secured to respective ribs of an upper surface and a lower surface of the polymer inner ring.

21. (canceled)

22. (canceled)
